(19) United States
(12) Patent Application Publication
(10) Pub. No.: US 2009/0159551 A1
(43) Pub. Date: Jun. 25, 2009

(54) Universal Adapter for Baby Nipple/Pacifier

(75) Inventor: Gregory R. Viggiano, Alexandria, VA (US)

Correspondence Address: SHOEMAKER AND MATTARE, LTD, 10 POST OFFICE ROAD - SUITE 100, SILVER SPRING, MD, 20910, US

(73) Assignee: Trio Child, LLC, Alexandria, VA (US)

(21) Appl. No.: 11/962,477

(22) Filed: Dec. 21, 2007

(51) Int. Cl. A61J 9/04

(52) U.S. Cl. 215/11.5

(57) ABSTRACT

A universal adapter for retaining a baby nipple/pacifier or other removable liquid dispenser on a bottle includes a substantially rigid closure having a downwardly extending rim, for engaging the mouth of a bottle from the outside, and a central upwardly extending fitting, with a central through aperture. The fitting is designed so that a liquid dispenser having a resilient mouth can be pushed onto the fitting. Contained within the closure is a resilient insert which includes an annular portion that acts as a gasket when the adapter is installed on the bottle. The resilient insert may have a central downwardly extending plug, formed integrally with the annular portion, which can be inserted into a narrow-mouthed bottle such as a water bottle.

### BACKGROUND OF THE INVENTION

This invention relates to a universal adapter for mounting a liquid dispenser such as a baby nipple/pacifier, sippy spout, or sports tip onto a liquid container such as a bottle.

### SUMMARY OF THE INVENTION

An object of the invention is to provide a device which can be used to mount various liquid dispensers on a variety of bottles, including both wide-mouth bottles like baby bottles and small-mouthed bottles like water bottles. The liquid dispenser may be a removable nipple or nipple/pacifier such as that shown in my U.S. Pat. No. 7,032,624, the contents of which are incorporated herein by reference. Alternatively, the liquid dispenser could be a removable sippy spout, or a removable sports tip (the push-pull spout commonly found on disposable water bottles). The term “liquid dispenser” as used herein is meant to be generic to nipples, sippy spouts, sports tips and the like. Whatever the dispenser type, it includes a resilient base, with an opening at the bottom, that can be pushed onto the adapter.

These and other objects are attained by a universal adapter for mounting a liquid dispenser on a bottle, as described below.

### BRIEF DESCRIPTION OF THE DRAWINGS

In the accompanying drawings,

FIG. 1 is a perspective view showing a first embodiment of a universal adapter embodying the invention, from above;

FIG. 2 is a perspective view thereof from below;

FIG. 3 is an exploded side view thereof;

FIG. 4 shows a modified form of the adapter, in which the central plug portion is removed;

FIG. 5 shows the adapter being mounted on a wide-mouthed baby bottle;

FIG. 6 is a perspective view of a second embodiment of an adapter embodying the invention, with a dust cover added, from above;

FIG. 7 is a side elevation thereof, with a transparent dust cover added;

FIG. 8 is a perspective view thereof, with a liquid dispenser installed in lieu of the dust cover; and

FIG. 9 is a sectional side view thereof.

### DESCRIPTION OF THE PREFERRED EMBODIMENT

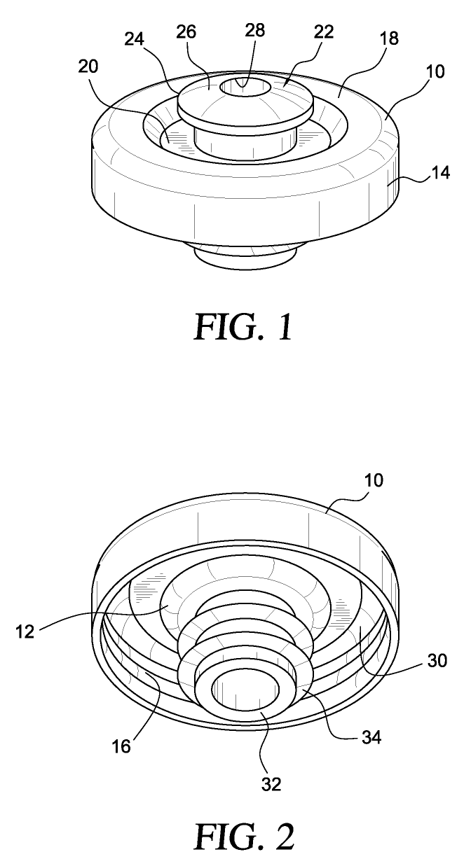

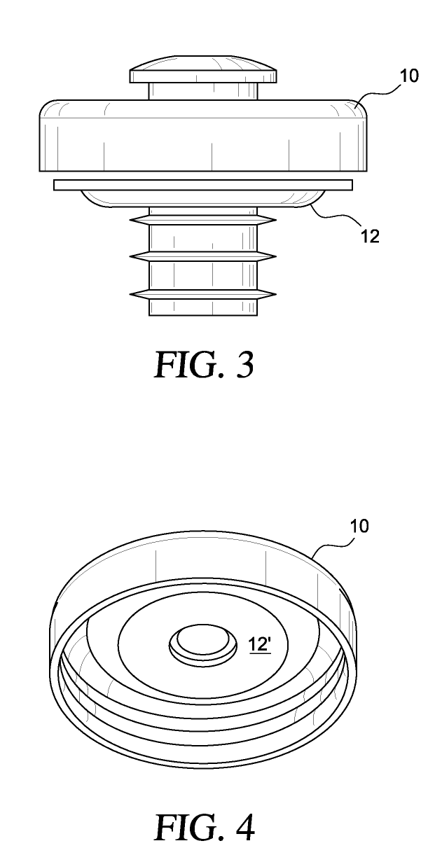

A universal adapter embodying the invention, as shown in FIGS. 1-5, preferably comprises two parts: a substantially rigid closure 10 made, for example, of a thermoplastic such as polypropylene and a softer or more resilient insert 12 (FIG. 2) which is seated in the closure. The insert may be made, for example, of a thermoplastic elastomer (TPE).

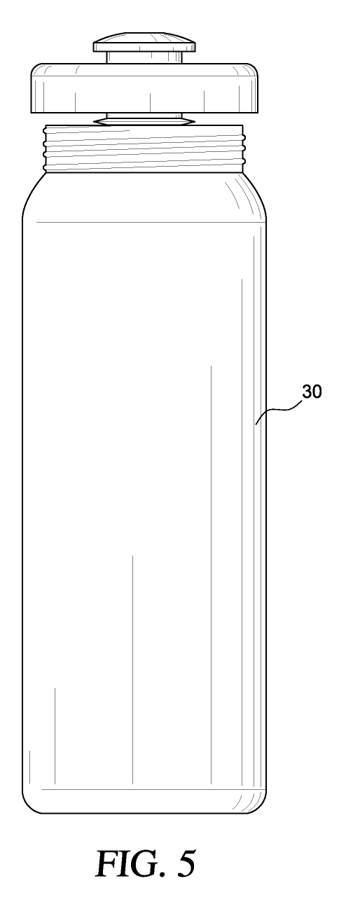

The closure 10 has a downwardly extending rim 14 with internal threads 16 for engaging complementary threads around the mouth of a conventional baby bottle (FIG. 5). The outer top portion 18 of the closure surrounds a central depression 20. A male fitting 22 extends upwardly from the center of the depression.

The fitting is substantially cylindrical, but has a peripheral rib or barb 24 near its upper end, which extends outward beyond the rest of the fitting. The top surface 26 of the fitting is rounded or conical to help center the liquid dispenser as its base is pushed onto the fitting.

The fitting has a central through aperture 28 which permits liquid to flow from the interior of the bottle to the liquid dispenser. A dust cover of some type, not shown in FIGS. 1-5, may be provided to protect the dispenser clean to prevent spillage and leakage during shipping and when the dispenser is not being used. One suitable closure is described below.

The resilient insert 12 includes an annular portion 30 that acts as a gasket when the adapter is installed on the bottle, and a central downwardly extending plug 32, formed integrally with the annular portion, which can be inserted into a narrow-mouthed bottle such as a water bottle. Preferably, the outer diameter of the plug is slightly less than the inner diameter of the narrow mouth, and a series of external annular ribs 34 are molded with the plug to provide a good seal with a narrow-mouthed bottle.

FIG. 4 shows a modification in which the central plug has been removed from the resilient insert 12′.

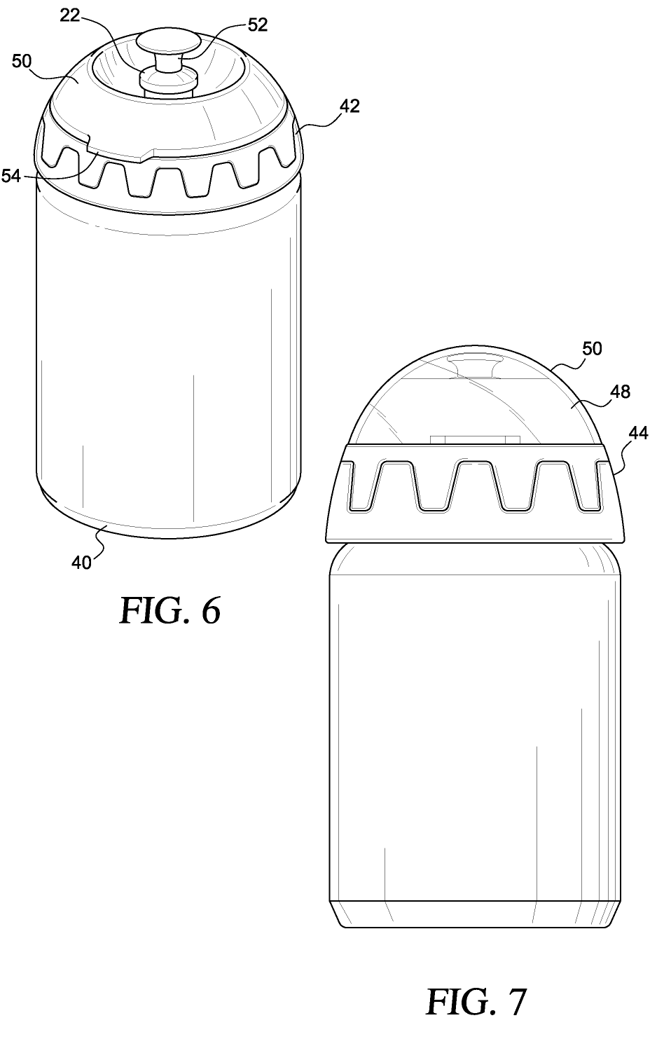

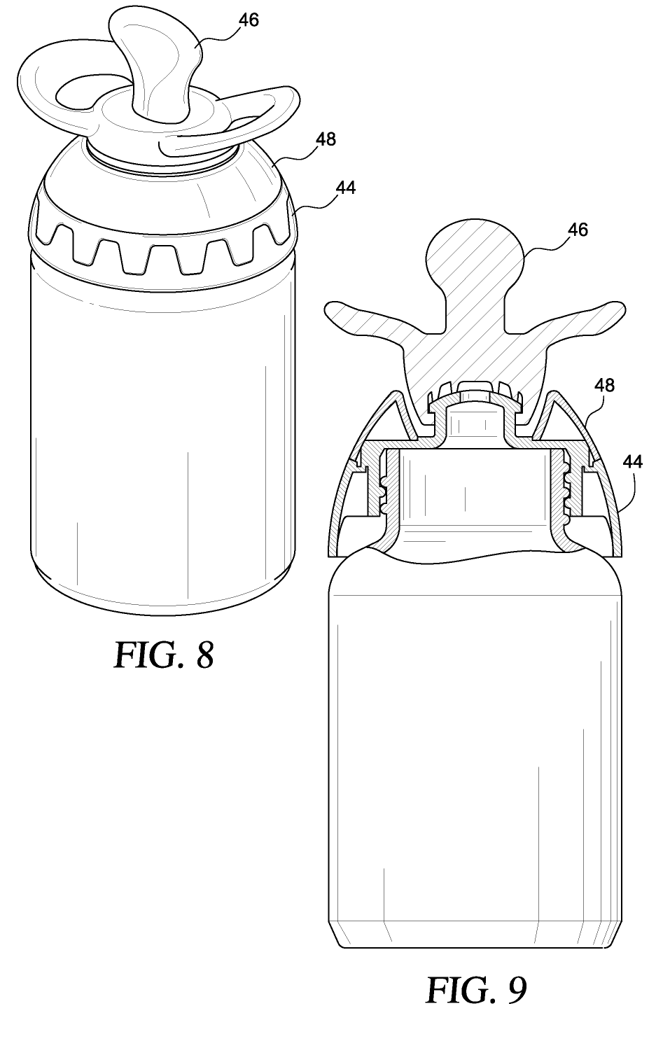

FIGS. 6-9 show a second embodiment of the invention. FIG. 6 depicts a baby bottle 40 (without a nipple) with a closure 42 mounted thereon. The closure, as can be seen particularly in FIG. 9, includes a main portion 44, molded in one piece, which mounted on the bottle and supports a liquid dispenser 46, plus a trim ring 48. The trim ring may be connected to the main portion by welding, by comolding, by an adhesive, or by a snap connection (not illustrated).

FIG. 7 shows the closure with a dust cover 50 added. The cover is preferably transparent or translucent, but could be opaque. The cover includes a finger 52, extending downward from its bottom surface at the center of the cover. The finger is slightly tapered so that it can enter the central aperture in the fitting and then block it to prevent leakage. Wedging of the finger in the aperture may provide sufficient retention force to keep the dust cover on the closure reliably, but alternatively, there could be an additional connection between the cover and the trim ring, for example a snap connection. The dust cover preferably is dome-shaped and fits closely over the trim ring, its outer surface forming a smooth and continuous extension of the outer skirt of the dust cover. A lift tab 54 most apparent in FIG. 6 enables one to remove the cover from the dust cover.

Since the invention is subject to modifications and variations, it is intended that the foregoing description and the accompanying drawings shall be interpreted as only illustrative of the invention defined by the following claims.

### Amendments to the Specification:

An object of the invention is to provide a device which can be used to mount various liquid dispensers on a variety of bottles, including both wide-mouth bottles like baby bottles and small-mouthed bottles like water bottles. The liquid dispenser may be a removable nipple or nipple/pacifier such as that shown in my U.S. Pat. No. 7,032,764, the contents of which are incorporated herein by reference. Alternatively, the liquid dispenser could be a removable sippy spout, or a removable sports tip (the push-pull spout commonly found on disposable water bottles). The term “liquid dispenser” as used herein is meant to be generic to nipples, sippy spouts, sports tips and the like. Whatever the dispenser type, it includes a resilient base, with an opening at the bottom, that can be pushed onto the adapter.

I claim:

1. A universal adapter for mounting a liquid dispenser on a liquid container, said adapter comprising
a closure having a downwardly extending rim, for engaging the mouth of a bottle from the outside, and a central upwardly extending fitting, with a central through aperture, the fitting being designed so that liquid dispenser having a resilient base can be pushed onto the fitting.

2. The adapter of claim 1, further comprising
a resilient insert contained within the closure, said insert comprising an annular portion which acts as a gasket when the adapter is installed on the bottle, and a central downwardly extending plug, formed integrally with the annular portion, which can be inserted into a narrow-mouthed bottle such as a bottled water container.

3. The adapter of claim 2, wherein the closure and the insert are made from different materials, the insert being of a material which is substantially more resilient than that of said closure.

4. The adapter of claim 2, further comprising a plurality of annular ribs on the outside surface of the plug of the insert, to provide fluid sealing against a bottle mouth into which it is inserted.

5. The adapter of claim 1, wherein the closure has a peripheral portion surrounding a central depression which the fitting is situated.

6. An adapter for mounting a liquid dispenser on a baby bottle, said adapter comprising
a closure having a downwardly extending rim, for engaging the mouth of a bottle from the outside, and a central upwardly extending fitting, with a central through aperture, the fitting being designed so that a liquid dispenser having a resilient mouth can be pushed onto the fitting.

7. The adapter of claim 6, wherein the closure has a peripheral portion surrounding a central depression which the fitting is situated.

8. The adapter of claim 6, further comprising a trim ring mounted on the closure around the fitting, the trim ring forming a depression in which the fitting is situated.

9. The adapter of claim 8, wherein the trim ring is permanently connected to the closure by welding, adhesive, or comolding.

10. The adapted of claim 8, wherein the trim ring is connected to the closure by a snap connector.

11. The adapter of claim 6, further comprising a dust cover which snaps in place over the fitting.

12. The adapter of claim 11, wherein the dust cover has structure which cooperates with complementary structure on the fitting to provide a snap connection.

13. The adapter of claim 12, wherein the structure on the dust cover engages within the central aperture of the fitting.

14. The adapter of claim 11, wherein the dust cover is transparent.

15. The adapter of claim 11, wherein the dust cover is opaque.

16. The adapter of claim 6, further comprising a liquid dispenser having a resilient mouth which can be pushed over the fitting.

17. The adapter of claim 16, wherein the base of the liquid dispenser has an inturned peripheral lip and the fitting has an outer peripheral rib of greater diameter than said lip, to positively retain the nipple/pacifier on the fitting.
